(19) United States
(12) Patent Application Publication
(10) Pub. No.: US 2025/0115778 A1
(43) Pub. Date: Apr. 10, 2025

(54) AQUEOUS ULTRAVIOLET FUSING AGENTS FOR COLORLESS THREE DIMENSIONAL PRINTED PARTS

(71) Applicant: Hewlett-Packard Development Company, L.P., Spring, TX (US)

(72) Inventors: Jake H. Thomas, San Diego, CA (US); Emre Hiro Discekici, San Diego, CA (US); Emily Levin, San Diego, CA (US)

(21) Appl. No.: 18/729,780

(22) PCT Filed: Jan. 26, 2022
(86) PCT No.: PCT/US2022/013846

§ 371 Date: Jul. 17, 2024

(51) Int. Cl. C09D 105/16; B29C 64/165; B29C 64/291; B29K 105/00; B33Y 10/00; B33Y 30/00; B33Y 70/00; C09D 7/20; C09D 7/45; C09D 7/63; C09D 7/65

(52) U.S. Cl. CPC C09D 105/16; B33Y 70/00; C09D 7/20; C09D 7/45; C09D 7/63; C09D 7/65; B29C 64/165; B29C 64/291; B29K 2105/005; B33Y 10/00; B33Y 30/00

(57) ABSTRACT

In example implementations, a three-dimensional printing kit for printing a colorless three-dimensional object in a three-dimensional printing system is provided. The three-dimensional printing kit includes a build material and an aqueous ultraviolet (UV) fusing agent. The aqueous UV fusing agent includes water in greater than 50 weight percent of the aqueous UV fusing agent and a UV absorber cyclodextrin complex.

### BACKGROUND

Three-dimensional (3D) printing may be an additive printing process used to make three-dimensional solid parts from a digital model. 3D printing can be often used in rapid product prototyping, mold generation, mold master generation, and short run manufacturing. Some 3D printing techniques are considered additive processes because they involve the application of successive layers of material. This is unlike customary machining processes, which often rely upon the removal of material to create the final part. 3D printing can often use curing or fusing of the building material, which for some materials may be accomplished using heat-assisted extrusion, melting, or sintering.

### BRIEF DESCRIPTION OF THE DRAWINGS

FIG. 1 is a block diagram of an example three-dimensional printing kit in accordance with the present disclosure;

FIG. 2 is a block diagram of another example three-dimensional printing kit in accordance with the present disclosure;

FIG. 3 is a schematic illustration of an example three-dimensional printing system that uses the three-dimensional printing kit of the present disclosure;

FIG. 4 is a schematic illustration of another example three-dimensional printing system that uses the three-dimensional printing kit of the present disclosure;

FIG. 5 is a flowchart illustrating an example method of selectively applying the three-dimensional printing kit of the present disclosure on a build material to print a three-dimensional object;

FIG. 6 illustrates a graph of a thermogravimetric analysis of pure avobenzone, pure beta-cyclodextrin, and a beta-cyclodextrin/avobenzone complex;

FIG. 7 illustrates a graph of a differential scanning calorimetry of pure avobenzone, pure beta-cyclodextrin, and a beta-cyclodextrin/avobenzone complex; and

FIG. 8 illustrates a graph of UV-Vis absorbance spectrum over time for an avobenzone dispersion compared to an avobenzone/cyclodextrin complex.

### DETAILED DESCRIPTION

Examples described herein provide aqueous ultraviolet (UV) fusing agents for colorless three dimensional (3D) printed parts. As discussed above, 3D printing may be an additive printing process that is used to make 3D solid parts from a digital model. 3D printing includes adding layers of build material. Layers of each object are “printed” in the build material with a fusing agent. The fusing agent absorbs light energy and converts the light energy into heat to heat a build material to a melting temperature of the build material. The build material can then be fused back together as the build material re-solidifies.

Some printing technologies, such as selective laser sintering (SLS) or multi-jet fusion (MJF) 3D printing, may print 3D parts using a polymer build material. MJF 3D printing uses a tungsten bronze low tint fusing agent (LTFA) that are fused with near infrared emitting light sources. However, these LTFAs can include cesium tungsten oxide which carries a blue tint. Thus, printing truly colorless parts can be impossible using LTFAs.

Some absorbers that absorb visible light (e.g., in the 455 nm range) may be water-soluble to enable ease of formulation in an aqueous system. However, the absorbers that absorb visible light all have a color tint due to their absorbance in the visible light spectrum. For example, some materials that absorb 455 nanometer (nm) light are yellow because they absorb blue light, but reflect yellow. This makes printing white or colorless parts with visible light absorbers difficult, if not impossible.

Printing truly colorless parts would enable printing of colored parts with a greater color gamut than when printed with the LTFA. In addition, printing truly colorless parts may increase recyclability. Although 3D printed parts containing carbon black may be recyclable, the rate at which the part can be recycled is reportedly low since the carbon black may inevitably tint any recycled materials derived from the 3D printed part containing carbon black.

An example of a colorless UV absorber is avobenzone. However, avobenzone is a highly hydrophobic compound that is insoluble in aqueous systems. Pure avobenzone in aqueous systems are usually delivered as a dispersion. Dispersions are thermodynamically unstable and prone to settling. In addition, pure avobenzone in aqueous systems is prone to thermal degradation with an onset less than 200 degrees Celsius (° C.).

The present disclosure provides an aqueous UV fusing agent that provides an aqueous avobenzone UV fusing agent that is thermally stable and remains soluble. In example, the avobenzone may be encapsulated with a cyclodextrin or its chemical analogues to form a complex that can be dissolved in aqueous systems. Thus, the avobenzone can be delivered in an aqueous system as a UV fusing agent that is more environmentally friendly than a solvent-borne system and can remain solubilized to allow the UV fusing agent to be thermodynamically stable over time.

In addition, the UV fusing agent of the present disclosure can fully solubilize the UV light absorber complex such that the UV fusing agent is free from particles that could potentially clog nozzles. The UV fusing agent of the present disclosure can keep the UV light absorber complex solubilized in an aqueous vehicle, which avoids particle aggregation over time providing a UV fusing agent that is stable over time.

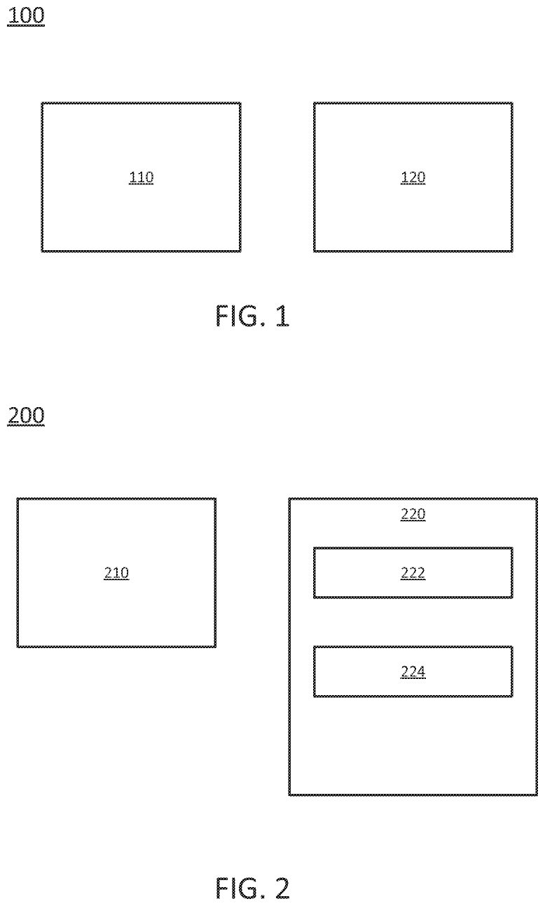

FIG. 1 illustrates a schematic illustration of an example three-dimensional printing kit 100 of the present disclosure. Three-dimensional printing kits can be used to make three-dimensional printed objects. A certain three-dimensional printing, or additive manufacturing, process can be performed using the materials described herein. In an example, UV fusing agents can be applied to layers of the build material. Successive layers of the build material can be added, and the UV fusing agents can be applied on the layers to fuse the particles of the build material together to form layers of a three-dimensional printed part.

In an example, the three-dimensional printing kit 100 of the present disclosure may include a build material 110 and an aqueous UV fusing agent 120. The build material 110 may be a powder. In an example, the build material 110 may be a polymer powder. Example build materials may include polyamides, modified polyamides, polyethylene, polyethylene terephthalate (PET), and copolymers of these materials. Other example build materials include polystyrene, polyacetals, polypropylene, polycarbonate, polyester, polyurethanes, other engineering plastics, and blends of any two or more of the polymers listed herein.

In an example, when the build material is in a powder form, the build material may be made up of similarly sized particles or differently sized particles. Size, as used herein, refers to the diameter of a spherical particle, or the average diameter of a non-spherical particle. In some examples, the average size of the particles of the build material in the build material composition ranges from about 10 micrometer (μm) to about 100 μm or about 40 μm to about 50 μm. In some examples, the diameter or average diameter of the particles may be measured using an analytical chemical analysis. For example, the average diameter of the particles are measured using a volume based size distribution. The size of the particles may be measured by using a static light scattering technique, such as laser diffraction.

In an example, the aqueous UV fusing agent 120 may include a UV light absorber complex that absorbs UV light that is solubilized in an aqueous based ink vehicle. The UV light may have a wavelength between 320 nanometers (nm) to 400 nm. In an example, the UV wavelength of light may be approximately 365 nm. FIG. 2 illustrates different formulations of the aqueous UV fusing agent 120.

FIG. 2 illustrates a schematic illustration of another example three-dimensional printing kit 200 of the present disclosure. In an example, three-dimensional printing kit 200 may include a build material 210 and an aqueous UV fusing agent 220.

In an example, the build material 210 may be similar to the build material 110 illustrated in FIG. 1, and described above. In an example, the build material 210 may be a polymer powder.

In an example, the aqueous UV fusing agent 220 may include water 222 (e.g., deionized water) and a UV light absorber complex 224. In an example, “aqueous UV fusing agent” may be defined as having more than 50 weight percent (wt %) of water. In other words, the aqueous UV fusing agent 220 may include more than 50 wt % of the water 222.

In an example, the UV light absorber complex 224 may be any type of colorless UV light absorber that can form a complex with cyclodextrin compounds or equivalent analogues. In an example, the UV light absorber complex 224 may include a complex formed between avobenzone and beta (β)-cyclodextrin. However, it should be noted that other cyclodextrins may also be used to form the avobenzone complex, such as alpha (α)-cyclodextrin, gamma (γ)-cyclodextrin, hydroxypropyl (β)-cyclodextrin, and the like.

In an example, the cyclodextrin (e.g., (β)-cyclodextrin) can encapsulate small molecule hydrophobic compounds to increase their compatibility in aqueous systems. (β)-cyclodextrin may provide a molecule that can achieve this function due to its ring-like structure, which contains a hydrophobic interior and hydrophilic exterior.

In an example, the aqueous UV agent 220 may include additional compounds. For example, the aqueous UV agent 220 may include a surfactant, a polyamide plasticizer co-solvent, a solubilizing co-solvent, and an additional solubilizer/crystallization inhibitor. The surfactant may improve jettability of the aqueous UV agent 220 and may include Tergitol 15-S-9.

The first co-solvent may be a polyamide plasticizer and/or have plasticizing characteristics when interacting with the build material 210. For example, the first co-solvent may interact with the build material 210 to lower the melting temperature of the build material 210. As a result, less UV light absorber complex 224 may be used and less energy may be used to melt the build material 210. The first co-solvent may be an organic solvent, such as benzyl alcohol.

The second co-solvent may be a solubilizer or a water miscible solvent that is compatible with the UV light absorber complex 224. The second co-solvent may help keep the UV light absorber complex 224 dissolved in the water 222 and help provide stability and prevent precipitation of the UV light absorber complex 224 over time. In other words, the UV light absorber complex 224 is solubilized and not a dispersion. The second co-solvent may include at least one of diethylene glycol (DEG) butyl ether, 1,2-hexanediol, hydroxyethyl-2-pyrrolidone (HE2P), propylene glycol, or 1,5-pentane diol.

In an example, the additional solubilizer/crystallization inhibitor may help the UV light absorber complex 224 to remain in solution and provide additional stability of the aqueous UV fusing agent 220 over time. Examples of the additional solubilizer may include Kolliphor RH40, BRIJ L23, and the like.

In an example, the formulation of the aqueous UV fusing agent 220 may include greater than 50 wt % of the water 222. In an example, the UV fusing agent 220 may include 50-70 wt % of the water 222. In an example, the UV fusing agent 220 may include approximately 51-55 wt % of the water 222.

In an example, the formulation of the aqueous UV fusing agent 220 may include 1-15 wt % of the UV light absorber complex 224. In an example, the UV fusing agent 220 may include 1 to 5 wt % of the UV light absorber complex 224.

In an example, the formulation of the aqueous UV fusing agent 220 may include 1-20 wt % of the first plasticizer co-solvent. In an example, the aqueous UV fusing agent 220 may include between 5-15 wt % of the first co-solvent. In an example, the aqueous UV fusing agent 220 may include approximately 10 wt % of the first co-solvent.

In an example, the formulation of the aqueous UV fusing agent 220 may include 20-50 wt % of the second solubilizer co-solvent. In an example, the aqueous UV fusing agent 220 may include between 25 to 45 wt % of the second co-solvent. In an example, the aqueous UV fusing agent 220 may include approximately 30 wt % of the second co-solvent.

In an example, the formulation of the aqueous UV fusing agent 220 may include between 0.1 to 1 wt % of the surfactant. In an example, the aqueous UV fusing agent 220 may include approximately 0.75 wt % of the surfactant.

In an example, the formulation of the aqueous UV fusing agent 220 may include between 1-3 wt % of the additional solubilizer/crystallization inhibitor. In an example, the formulation of the aqueous UV fusing agent 220 may include approximately 3 wt % of the additional solubilizer/crystallization inhibitor.

Example formulations of the aqueous UV fusing agent 220 are provided below.

### Example 1

| Component | wt % |
|---|---|
| Tergitol 15-s-9 | 0.75 |
| (β)- | 2.0 |
| cyclodextrin/avobenzone | |
| complex | |
| Benzyl alcohol | 10.0 |
| 1,2 hexane diol | 30 |
| Kolliphor RH40 | 3 |
| Water | 54.25 |

### Example 2

| Component | wt % |
|---|---|
| Tergitol 15-s-9 | 0.75 |
| Hydroxypropyl (β)- | 5.0 |
| cyclodextrin/avobenzone | |
| complex | |
| Benzyl alcohol | 10.0 |
| 1,2 hexane diol | 30 |
| Kolliphor RH40 | 3 |
| Water | 51.25 |

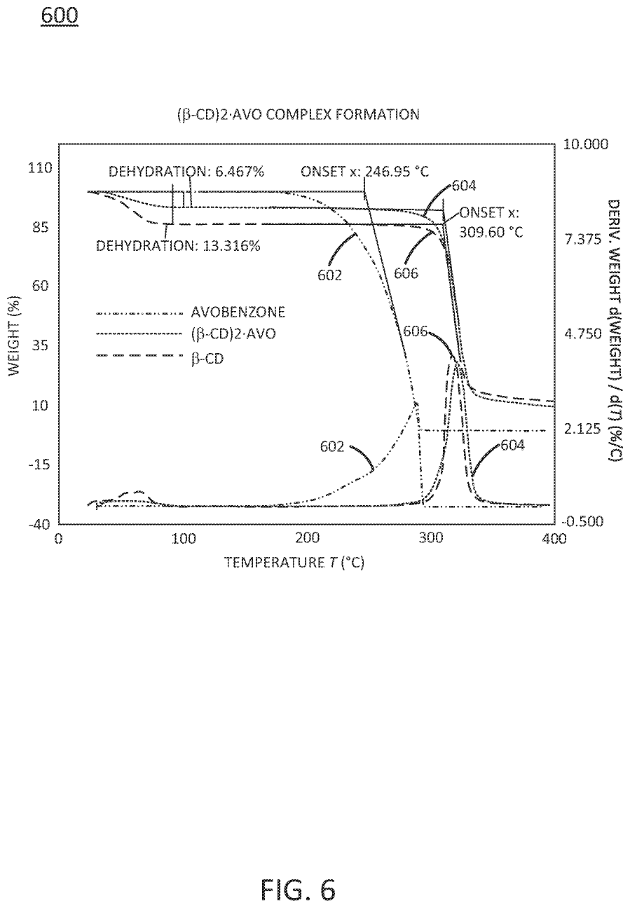

FIGS. 6-8 illustrate evidence of solubilization of the avobenzone when formed into a complex in mixed in an aqueous ink vehicle and demonstrate the stability of the avobenzone complex aqueous based UV fusing agent over time. In an example, to test the ability of β-cyclodextrin to increase the hydrophilic nature of avobenzone, a complex was formed by mixing a 2:1 mole ratio of β-cyclodextrin to avobenzone. The powder blend was shaken with water & milling beads to form the (β-cyclodextrin)₂·avobenzone complex, which was confirmed with thermogravimetric analysis (TGA). TGA results, shown by graph 600 in FIG. 6, confirm that the (β-cyclodextrin)₂·avobenzone complex was formed. Pure avobenzone (line 602) is seen to degrade with an onset temperature (as measured by tangent lines) of 247° C., whereas the pure β-cyclodextrin (line 606) and the (β-cyclodextrin)₂·avobenzone complex (line 604) show a degradation onset around 310° C. This finding suggests that the (β-cyclodextrin)₂·avobenzone complex can withstand higher temperatures in the MJF process before degrading thermally. This same study was conducted with the (hydroxypropyl-β-cyclodextrin)₂·avobenzone complex with similar findings indicating successful complexation.

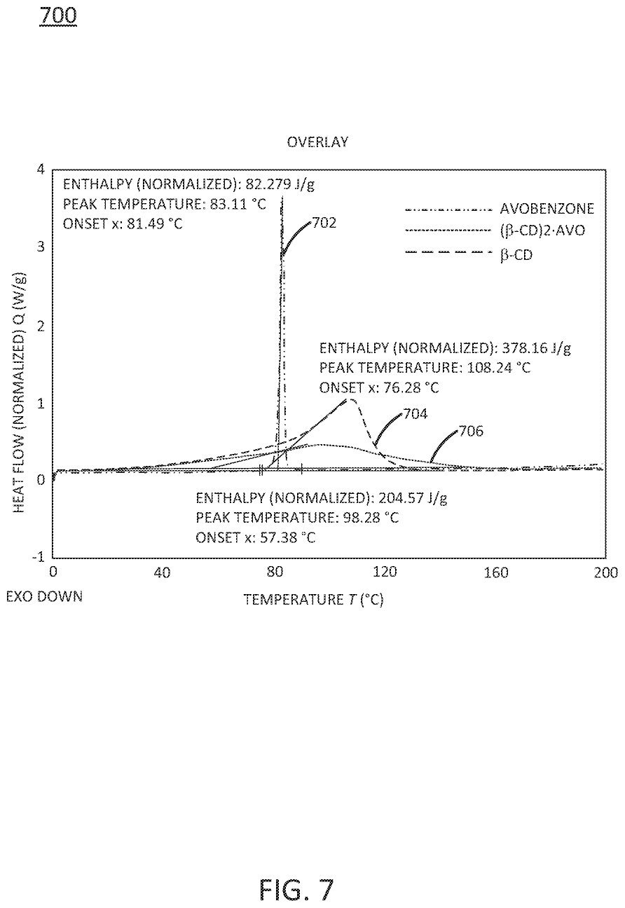

Furthermore, the purity of the sample was confirmed using differential scanning calorimetry (DSC) as shown by graph 700 in FIG. 7. The DSC graph shows a sharp melting point for avobenzone centered around 83° C. (line 702) whereas pure β-cyclodextrin (line 704) and (β-cyclodextrin)₂·avobenzone complex (line 706) show a broad melting transition.

Solubility studies were conducted with the three powder samples (e.g., pure avobenzone, β-cyclodextrin, and (β-cyclodextrin)₂·avobenzone complex) to understand the impact on ease of formulation. The three materials were added to either DI water, or a representative ink vehicle at 1 wt % concentration. After mixing and allowing time to dissolve, it is apparent that β-cyclodextrin and (β-cyclodextrin)₂·avobenzone complex have superior solubility characteristics to pure avobenzone. The β-cyclodextrin was soluble in water as well as ink vehicle, the pure avobenzone was insoluble in both, and the β-cyclodextrin)₂·avobenzone complex was completely soluble in the ink vehicle.

To illustrate the improvements in avobenzone thermal stability, two avobenzone formulations were subjected to an accelerated shelf life (ASL) aging test in a 60° C. oven for two weeks: an avobenzone/cyclodextrin complex formula using Example 1 described above and an avobenzone dispersion formula. An example formulation of the comparative avobenzone dispersion formula is provided below:

### Comparative Avobenzone Dispersion Formulation:

| Component | wt % |
|---|---|
| Tergitol 15-s-9 | 0.75 |
| Avobenzone | 5.0 |
| Disperbyk-190 | 0.25-2 |
| Propylene glycol | 30 |
| Isopropyl alcohol | 1 |
| Water | 30-70 |

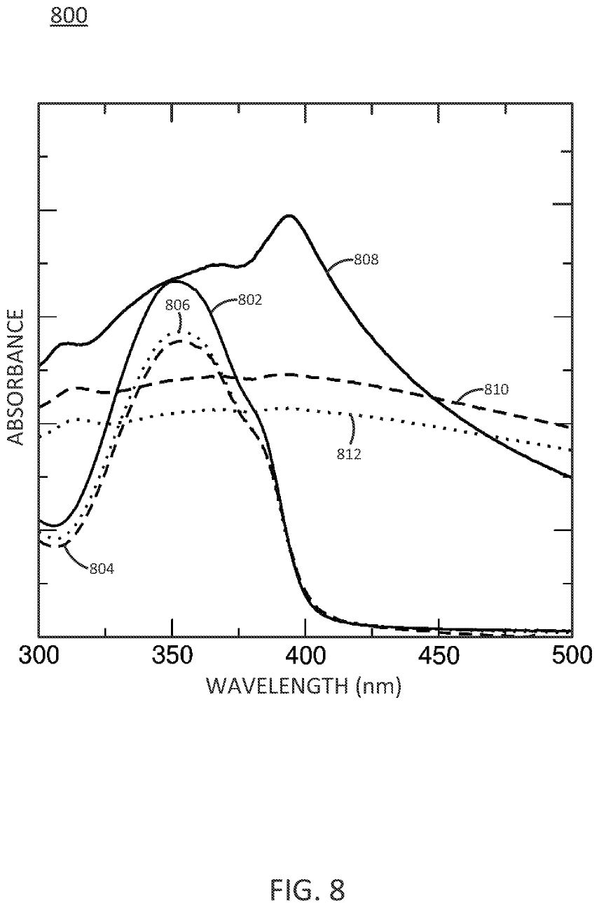

The UV-vis absorbance spectra was measured for each agent before ASL testing and after 2 weeks in ASL conditions. The resulting spectra are shown by graph 800 in FIG. 8.

For example, line 808 represents the avobenzone dispersion at week 0, line 810 represents the avobenzone dispersion at week 2, and line 812 represents the avobenzone dispersion at week 4. Line 802 represents the (β-cyclodextrin)₂·avobenzone complex of Example 1 at week 0, line 804 represents the (β-cyclodextrin)₂·avobenzone complex of Example 1 at week 2, and line 806 represents the (β-cyclodextrin)₂·avobenzone complex of Example 1 at week 4. As can be seen in the graph 800 the (β-cyclodextrin)₂·avobenzone complex of Example 1 has less degradation over a 4 week timespan than the avobenzone dispersion.

Thus, the present disclosure provides an aqueous UV fusing agent 120 and 220 that allows formulation of UV absorbers (e.g., avobenzone) into an aqueous ink vehicle with greater than 50 wt % of water and allows for colorless 3D printing. The aqueous UV fusing agent 120 and 220 may improve the thermal stability of the avobenzone over non-complexed avobenzone and improve the ink stability over a dispersion delivery method of the avobenzone.

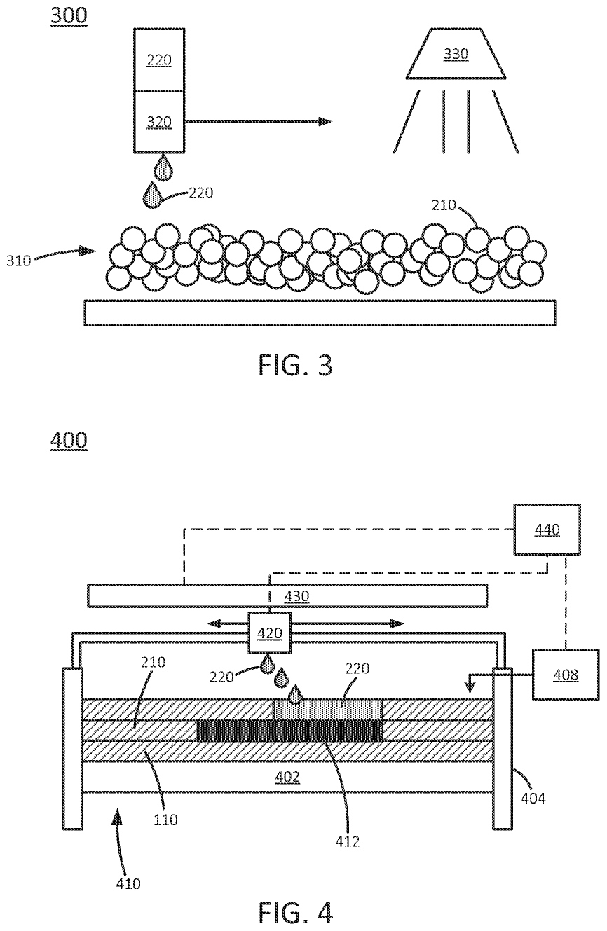

FIG. 3 illustrates an example of a three-dimensional printing system 300 that can use the three-dimensional printing kit 100 or 200 described above. The three-dimensional printing system 300 can be used with three-dimensional printing kit 100 or 200 described herein to make three-dimensional printed objects. In some examples, a three-dimensional printing system can include a powder bed for holding layers of the build material. A fusing agent applicator 320 can be positioned to selectively apply the aqueous UV fusing agent 120 or 220 onto the layers of build material 110 or 210. For example, the fusing agent applicator 320 can be controllable to apply the colorless fusing agents at specific, x/y coordinates of the layer of build material 310. Additionally, the three-dimensional printing systems can include a fusing lamp. As used herein, “fusing” can refer to a process of heating the build material 110 or 210 and the aqueous UV fusing agents 120 or 220 so that build material is melted and then allowed to fuse back together when cooled.

In an example, the three-dimensional printing system 300 may include a powder bed 310. The example illustrated in FIG. 3 uses the build material 210 and the aqueous UV fusing agent 220. However, it should be noted that the three-dimensional printing system 300 may also use the build material 110 and the aqueous UV fusing agent 120.

In an example, the powder bed 310 includes a layer of the build material 210. As noted above, the build material 210 includes particles of a polymer. The printing system 300 may also include a fusing agent applicator 320. The fusing agent applicator 320 is fluidly coupled to an aqueous UV fusing agent 220. The UV fusing agent applicator 320 can be controlled to iteratively apply the aqueous UV fusing agent 220 on desired locations of layers of the build material 210.

The printing system 300 may also include a fusing lamp 330 positioned to emit wavelengths of light to be absorbed by the aqueous UV fusing agent 220. The fusing lamp 330 may emit light having a UV wavelength (e.g., between 320 nm to 400 nm). In an example, the fusing lamp 330 may emit light having a wavelength of approximately 365 nm. The absorbed light can be converted into heat to melt the particles of the build material 210. Although the fusing lamp 330 is illustrated above the powder bed 310, it should be noted that the fusing lamp 330 may also be positioned below the powder bed 310.

In some examples, a detailing agent may also be used. Multi-jet fusion employs the detailing agent as a cooling agent that is applied to certain regions of the build to control thermals in the build bucket. The detailing agent is often printed in regions just superficial to the boundary of the part to prevent over fusing of surrounding powder onto the part edges. The detailing agent can also be applied within the body of large and bulky volumes within parts to prevent over temperature defects which can arise from excessive temperatures.

It should be noted that the three-dimensional printing system 300 has been simplified for ease of explanation and can include a variety of additional components besides the components shown in FIG. 3. Examples of additional components include a build material distributor, a supply of additional build material, a fluid applicator for applying a binding agent, a hardware controller to send instructions to other components in the system, a non-transitory computer readable medium having stored computer executable instructions to cause the hardware controller to send instructions to other components of the system to perform a three-dimensional printing method, a sintering oven, and the like.

FIG. 4 illustrates another example three-dimensional printing system 400. The example printing system 400 illustrated in FIG. 4 uses the build material 210 and the aqueous UV fusing agent 220. However, the printing system 400 may also use the build material 110 and the aqueous UV fusing agent 120.

In an example, the printing system 400 includes a powder bed 410 having a build material platform 402 and side walls 404. A build material applicator 408 is configured to deposit individual layers of the build material 210.

The printing system 400 may also include a UV fusing agent applicator 420 that is positioned above the powder bed 410. The UV fusing agent applicator 420 may be moveable so that the UV fusing agent applicator 420 can apply the aqueous UV fusing agent 220 on to the layers of the build material 210.

A fusing lamp 430 may be positioned to emit wavelengths of light that are absorbed by the aqueous UV fusing agent 220. The absorbed light can be converted into heat to heat the powder bed 410. In this example, the fusing lamp 430 may heat the individual layers of the build material 210 after the aqueous UV fusing agent 220 is applied to selective areas of a layer of the build material 210. The process may be repeated for each layer as the 3D object is printed layer by layer.

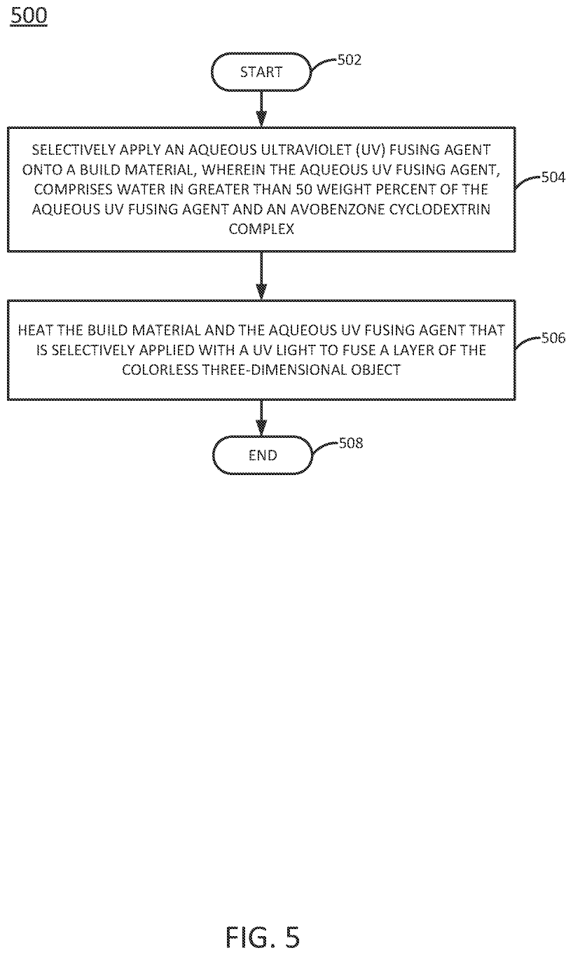

The printing system 400 may also include a hardware controller 440 or processor. The hardware controller 440 may communicate with the fusing lamp 430, the UV fusing agent applicator 420, and the build material applicator 408 to send instructions to the fusing lamp 430, the UV fusing agent applicator 420, and the build material applicator 408 to perform a three-dimensional printing method (e.g., the method 500 illustrated in FIG. 5, and described below).

In some examples, the UV fusing agent applicator 420 can be moveable along two axes, such as an x-axis and a y-axis, to allow the aqueous UV fusing agent 220 to be selectively applied to any desired location on the layers of build material 210. In other examples, the UV fusing agent applicator 420 can be large enough to extend across one entire dimension of the powder bed 410, and the UV fusing agent applicator 420 can be moveable along one axis.

For example, the UV fusing agent applicator 420 can include a plurality of nozzles along the length of the UV fusing agent applicator 420, and the aqueous UV fusing agent 220 can be selectively jetted from the individual nozzles. The UV fusing agent applicator 420 can then scan across the powder bed 410 and the aqueous UV fusing agent 220 can be selectively jetted from the nozzles to allow the aqueous UV fusing agent 220 to be applied to any desired location on the powder bed 410.

In another example, the UV fusing agent applicator 420 can extend in one dimension across the powder bed 410. The UV fusing agent applicator 420 may be movable along another axis. The height above the powder bed 410 is constant. The UV fusing agent 220 is jetted out of select nozzles across the one dimension as the UV fusing agent applicator 420 moves in the other dimension.

In other examples, the powder bed 410 itself can be moveable. For example, the powder bed 410 can be moveable and the UV fusing agent applicator 420 can be stationary. In either example, the UV fusing agent applicator 420 and the powder bed 410 can be configured so that the aqueous UV fusing agent 220 can be selectively applied to specific portions of the powder bed 410.

The UV fusing agent applicator 420 can be configured to print drops of the aqueous UV fusing agent 220 at a resolution ranging from about 300 dots per inch (DPI) to about 1200 DPI in some examples. Higher resolutions or lower resolutions can also be used. The volume of individual drops of aqueous UV fusing agent 220 can be from about 1 Pico liters (pL) to about 400 pL in some examples. The firing frequency of nozzles of the agent applicator can be from about 1 kilohertz (kHz) to about 100 kHz in certain examples.

FIG. 5 illustrates a flow diagram of an example method 500 for selectively applying the three-dimensional printing kit on a build material to print a three-dimensional object of the present disclosure. In an example, the method 500 may be performed by the printing system 300 illustrated in FIG. 3 or the printing system 400 illustrated in FIG. 4 using the three-dimensional printing kit 100 illustrated in FIG. 1 or the three-dimensional printing kit 200 illustrated in FIG. 2.

At block 502, the method 500 begins. At block 504, the method 500 selectively applies an aqueous ultraviolet (UV) fusing agent onto a build material, wherein the aqueous UV fusing agent, comprises water in greater than 50 weight percent of the aqueous UV fusing agent and an avobenzone cyclodextrin complex. For example, a layer of the build material may be deposited onto a powder bed. The build material may be leveled to provide a smooth even layer of the build material.

In an example, the UV light absorber complex may be a complex of a colorless UV absorber. In an example, the complex may be a complex of avobenzone. In one example, the complex may be a cyclodextrin based complex of avobenzone. For example, the cyclodextrin may include (β)-cyclodextrin, hydroxypropyl (β)-cyclodextrin, (α)-cyclodextrin, (γ)-cyclodextrin, and the like. The aqueous UV fusing agent may include 1-15 wt % of the avobenzone cyclodextrin complex UV light absorber complex.

In an example, the UV fusing agent may include additional components, such as a first plasticizer co-solvent, a second solubilizer co-solvent, a surfactant, and an additional solubilizer. Example formulations of the UV fusing agent are described above in Example 1 and Example 2.

At block 506, the method 500 heats the build material and the aqueous UV fusing agent that is selectively applied with a UV light to fuse a layer of the colorless three-dimensional object. For example, a fusing lamp may emit UV wavelength of light that is absorbed by the aqueous UV fusing agent. For example, the UV wavelength of light may be between 320 nm to 400 nm. In an example, the fusing lamp may emit light at a wavelength of approximately 365 nm.

The aqueous UV fusing agent may convert the absorbed light energy into heat to heat the selected locations of the build material where the UV fusing agent is applied. The heat may locally melt the build material and allow the build material to fuse together when solidified.

The method 500 may repeat blocks 504 and 506 for multiple layers of the colorless three-dimensional object until printing of the colorless three-dimensional printed object is completed. Each layer may include a bound portion that forms a portion of the three-dimensional object that is to be printed. The method 500 may then melt the layers that are bound of the three-dimensional object to form a three-dimensional printed object. At block 508, the method 500 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A three-dimensional printing kit, comprising:
a build material; and
an aqueous ultraviolet (UV) fusing agent, comprising:
water in greater than 50 weight percent of the aqueous UV fusing agent; and
a UV absorber cyclodextrin complex.

2. The three-dimensional printing kit of claim 1, wherein a UV absorber of the UV absorber cyclodextrin complex comprises avobenzone.

3. The three-dimensional printing kit of claim 1, wherein a cyclodextrin of the UV absorber cyclodextrin complex comprises β-cyclodextrin.

4. The three-dimensional printing kit of claim 3, wherein the UV absorber cyclodextrin complex with β-cyclodextrin comprises 1-2 weight percent of the aqueous UV fusing agent.

5. The three-dimensional printing kit of claim 1, wherein a cyclodextrin of the UV absorber cyclodextrin complex comprises hydroxypropyl β-cyclodextrin.

6. The three-dimensional printing kit of claim 5, wherein the UV absorber cyclodextrin complex with hydroxypropyl β-cyclodextrin comprises 1-15 weight percent of the aqueous UV fusing agent.

7. The three-dimensional printing kit of claim 1, wherein the UV absorber cyclodextrin complex is dissolved in the water.

8. The three-dimensional printing kit of claim 1, wherein the aqueous UV fusing agent, further comprises:
a surfactant;
a first plasticizer co-solvent; and
a second solubilizing co-solvent.

9. A three-dimensional printing system, comprising:
a powder bed comprising a layer of build material;
an aqueous ultraviolet (UV) fusing agent applicator fluidly coupled to a supply of an aqueous UV fusing agent, wherein the aqueous UV fusing agent applicator is to iteratively apply the aqueous UV fusing agent to the layer of build material, wherein the aqueous UV fusing agent comprises water in greater than 50 weight percent of the aqueous UV fusing agent and a UV absorber cyclodextrin complex; and
a fusing lamp positioned to emit UV light to heat the powder bed to a fusing temperature.

10. The three-dimensional printing system of claim 9, wherein a wavelength of the UV light is between 320 nanometers (nm) to 400 nm.

11. The three-dimensional printing system of claim 9, wherein the UV absorber cyclodextrin complex comprises an avobenzone β-cyclodextrin complex or an avobenzone hydroxypropyl β-cyclodextrin complex.

12. The three-dimensional printing system of claim 9, wherein the aqueous UV fusing agent, further comprises:
a first solvent to provide a polymer plasticizer;
a second solvent that is water miscible;
a surfactant; and
an additional solubilizer.

13. A method of printing a colorless three-dimensional object, comprising:
selectively applying an aqueous ultraviolet (UV) fusing agent onto a build material, wherein the aqueous UV fusing agent, comprises water in greater than 50 weight percent of the aqueous UV fusing agent and an avobenzone cyclodextrin complex; and
heating the build material and the aqueous UV fusing agent that is selectively applied with a UV light to fuse a layer of the colorless three-dimensional object.

14. The method of claim 13, wherein the avobenzone cyclodextrin complex comprises 1-15 weight percent of the aqueous UV fusing agent.

15. The method of claim 13, wherein the selectively applying the aqueous UV fusing agent and the heating the build material and aqueous UV fusing agent are repeated for a plurality of layers of the colorless three-dimensional object until printing of the colorless three-dimensional printed object is completed.
